(19) United States
(12) Patent Application Publication
(10) Pub. No.: US 2010/0059528 A1
(43) Pub. Date: Mar. 11, 2010

(54) Apparatus for gas storage

(75) Inventors: Nikolay ZHEVAGO, Moscow (RU); Emil DENISOV, Moscow (RU); Zeev PARNES, Kfar-Baruch (IL)

Correspondence Address: HOUSTON ELISEEVA, 4 MILITIA DRIVE, SUITE 4, LEXINGTON, MA, 02421, US

(73) Assignee: C. EN. LIMITED, Road Town (VG)

(21) Appl. No.: 12/208,915

(22) Filed: Sep. 11, 2008

(51) Int. Cl. F17C 1/02; F17C 5/06; F17C 13/02

(52) U.S. Cl. 220/592; 220/581; 141/82; 141/83

(57) ABSTRACT

An apparatus for gas storage is described. The apparatus contains a storage array structure including a gas storage portion tapered into at least one neck portion at one end of the structure. The storage array structure includes a plurality of tubular chambers for gas storage. At least a portion of an outer surface of the storage array structure is enveloped by at least one reinforcing layer for providing reinforcing strength thereto. The apparatus also includes at least one interface coupler mounted on the reinforcing layer at the neck portion. The interface coupler is configured for coupling the tubular chambers of the storage array structure to a gas pipe through which the gas can be supplied to the chambers of the array structure or discharged therefrom.

### FIELD OF THE INVENTION

The present invention relates generally to fuel storage, and in particular, to an apparatus for gas storage.

### BACKGROUND OF THE INVENTION

In recent times, there has been an increasing move towards powering cars and other vehicles with fuel cells running on gas. For example, fuel based on very efficient and clean-burning hydrogen is a highly attractive alternative to traditional gasoline fuel. Fuel cell-powered vehicles combining hydrogen with air to produce electricity to power the vehicles, have the potential to provide a solution to air quality problems. For example, when hydrogen is combined in a fuel cell with oxygen through combustion, or through a fuel cell mediated oxidation/reduction reactions, the primary product of this reaction is water, which is non-polluting and can be recycled to regenerate hydrogen and oxygen.

A key issue for operation of hydrogen fuel cells is the availability of hydrogen on-board a vehicle. Hydrogen can be provided either as a compressed gas, as a cryogenic liquid, or as an adsorbed element using metal hydride storage. Of these alternatives, compressed hydrogen is considered the best near-term solution for hydrogen storage on a motor vehicle due to the relative simplicity of gaseous hydrogen, rapid refueling capability, excellent dormancy characteristics, low infrastructure impact, and low development risk.

With increased fuel requirements, capacity of hydrogen-storage tanks becomes a highly important issue. Tank capacity is defined here as the maximum amount of the compressed hydrogen that can be stored within a storage tank at a certain pressure. To make the tanks applicable to vehicles, the hydrogen pressures have to be increased greatly, which results in increase in both the tank weight and the material cost.

Various high pressure tanks for storage of pressurized hydrogen are known in the art. For example, a hydrogen-storage container which demonstrates a high hydrogen-storage capacity, which is reduced in mass, and which is suited to be installed in an automobile is described in U.S. Patent Application No. 2005/145378 to Kimbara. The hydrogen-storage container holds a hydrogen-occlusion alloy in which hydrogen is occluded. An air gap portion formed in the container is filled with hydrogen gas whose pressure is above a plateau equilibrium pressure of hydrogen gas contained in the hydrogen-occlusion alloy at a temperature of a location where the hydrogen-storage apparatus is installed. This hydrogen-storage container has a liner made of metal or resin, and a fiber-reinforced resin layer provided outside the liner.

In order to reduce structural weight, storage tanks manufactured from fiber composite materials are known. An internal structure of such tanks can be made of stainless steel or aluminum and be enveloped with glass and/or carbon fibers. Tanks made of plastic materials are also known.

Hydrogen as the smallest element has a very high permeability rate through many materials. Hydrogen permeation leads also to another problem with hydrogen storage vessels. Hydrogen migration into the metal can cause reactions within the tank structure and result in hydrogen embrittlement due to which metal, from which the tank is formed, becomes brittle and crack. Hydrogen embrittlement leads to a serious reduction in ductility and then results in cracking and failures well below the normal yield stresses. High tensile strength, low density and nonreactivity with hydrogen along with low diffusivity are thus desired properties for hydrogen storage tanks. For example, carbon composites have high yield stresses and low densities, but they do not offer any solution to hydrogen leakage which results in capacity reduction during operation. Therefore hydrogen barrier coatings such as liners can be required for carbon composites to stop the hydrogen escaping and to keep the usable hydrogen capacity at hand. Liners are usually compounds such as aluminum and copper alloys or polymers, such as cross-linked polyethylene covered with a graphite fiber epoxy layer.

Further, in order to increase hydrogen storage capacity of the storage apparatus, the apparatus can comprise a number of gas storage tanks. For example, U.S. Pat. No. 7,112,239 to Kimbara et al. discloses a hydrogen storage apparatus including multiple gas storage tanks. The multiple gas storage tanks are disposed longitudinally parallel to each other in an ordered fashion such that roughly triangular prism-shaped empty spaces are formed between multiple adjacent hydrogen storage tanks. Coolant paths through which coolant flows, are formed in these roughly triangular prism-shaped empty spaces.

It is also known that hydrogen storage capacity of the storage apparatus can be increased by storing compressed hydrogen in microcapsules, such as hollow microspherical and/or microcylindrical (multi-capillary) assemblies. Such microcapsules can have high tensile strength, low density, nonreactivity with hydrogen along with low diffusivity and good conformity with fuel storage volumes available on a vehicle.

For example, U.S. Pat. No. 4,328,768 to Tracy et al. describes a fuel storage and delivery system wherein hollow microspheres filled with hydrogen gas are stored in a fuel storage chamber at pressures of 400 atmospheres. From the fuel storage chamber the microspheres are directed through a heated delivery chamber wherein hydrogen gas is freed by diffusion and delivered to an engine, after which the substantially emptied microspheres are delivered to a second storage chamber. The substantially emptied microspheres are removed by mechanical means, such as a pump, to a storage chamber from which they can be removed for refilling.

International Publication No. WO2005/028945A2 to Vik describes a storage apparatus for storing a highly pressurized gas such as hydrogen. The apparatus comprises an outer vessel (i.e., tank), a plurality of separately sealed inner vessels (i.e., microcapsules) and means for communication with the interiors of the inner vessels and of the outer vessel. The inner and outer vessels may be of any suitable shape. For example, the inner vessels are substantially spherical. Alternatively, the inner vessels are in the form of tubes which are preferably straight and parallel to one another. The inner vessels are made of carbon fiber reinforced epoxy.

International Publication No. WO2006/046248A1 to Chabak describes a hydrogen accumulation and storage material and a method of forming thereof. The material comprises a plurality of various-sized and at least partially permeable to hydrogen microspheres bound together to form a rigid structure in which a diameter of the microspheres is reduced from a center of the structure towards edges of the structure. An outer surface of the rigid structure can be enveloped by a sealing layer, thereby closing interspherical spaces.

International Publication No. WO2007/072470A1 to Gnedenko, et al. describes an apparatus for storage of compressed hydrogen gas. The apparatus includes a sealed housing that defines a chamber that includes a cartridge comprising a plurality of cylindrical voids containing the compressed hydrogen gas. The apparatus also includes a hydrogen liberating tool configured for controllable liberating the hydrogen gas from the cartridge into a volume of the chamber that is not occupied by the cartridge.

According to one embodiment described in WO2007/072470, the cartridge includes an assembly structure formed of a plurality of closely packed hollow microcylinders having sealed ends. In this case, the hydrogen discharging tool can include an electrically heating element, such as a wire woven within the cartridge in empty inter-cylinder spaces along the microcylinders, for discharging the hydrogen stored within the microcylinders into the inter-cylinder spaces and the other volume of the case that is not occupied by the microcylinders. Alternatively, the discharging tool can include a mechanical opener that is mounted on a shaft of an electric drive and configured for gradual destroying of the microcylinder ends proximal to the discharging tool.

According to another embodiment described in WO2007/072470, the cartridge includes a monolithic block having a plurality of cylindrical cavities. The ends of the cavities, proximate to the hydrogen discharging tool, are covered with a hydrogen diffuser plate. In this case, the hydrogen discharging tool includes a controllable radiation source for providing photo-enhanced diffusion of hydrogen through the hydrogen diffuser plate.

### SUMMARY OF THE INVENTION

Despite the known techniques in the area of fuel storage, there is still a need in the art for further improvement of the technique for accumulation and storage of hydrogen in order to provide a more effective hydrogen load and liberation, which will result in increased safety and cost-saving.

It would be useful to have an apparatus that can have a conformable structure and thus be provided in any suitable form, making it more suitable for industrial and/or private operation and transportation, when compared to the prior art techniques.

It would be also advantageous to have a method and apparatus that can feature higher gas-storage capacity and operate at higher weight content of the gas, and which will lower losses of the gas during its storage, resulting in increased safety and cost-saving, when compared to the prior art techniques.

The present invention partially eliminates disadvantages of the prior art techniques and describes a novel apparatus for storage and liberation of compressed hydrogen gas. The apparatus contains a storage array structure including a gas storage portion tapered into one or more neck portions at the ends of the structure. The storage array structure includes a plurality of tubular chambers for gas storage. At least a portion of an outer surface of the storage array structure is enveloped by at least one reinforcing layer for providing reinforcing strength thereto. The reinforcing layers can, for example, be made of carbon fiber reinforced epoxy.

The apparatus also includes one or more interface couplers mounted on the reinforcing layer at the neck portion. The interface coupler(s) can be configured for coupling the tubular chambers of the storage array structure to one or more gas pipes through which the gas can be supplied to the chambers of the array structure or discharged therefrom. The apparatus also includes one or more controllable gas valves coupled to the interface coupler. An ingress flow of the gas through the interface coupler provided for filling the storage array structure and an egress flow of the gas through the interface coupler provided for discharge of the gas can be both regulated by the controllable gas valve.

According to an embodiment of the present invention, at least part of the reinforcing layer is enveloped by a damping layer for protection of the apparatus from bumps.

According to an embodiment of the present invention, the apparatus can comprise at least one safety valve coupled to the tubular chambers of the structure and configured for automatic opening when pressure in the chambers reaches a dangerous level.

According to one embodiment, the storage array structure includes a plurality of closely packed hollow microtubes having ends on the opposite sides of the hollow microtubes. The ends of the microtubes on one side of the array structure are sealed, whereas the ends on the opposite side are coupled to the interface coupler, thereby defining the tubular chambers in the form of cavities in the structure in which the compressed hydrogen gas is stored.

The hollow microtubes can, for example, be made of a material having a ratio of the tensile strength to the density of the material greater than 1700 MPa·cm³/g. The external diameter of the hollow microtubes can decrease from the center of the structure towards the edges (periphery) of the structure. The wall thickness of the hollow microtubes may decrease from a center of the structure towards edges of the structure. Examples of the cross-sectional shape of the cavities in the structure include, but are not limited to, round shape, oval shape, polygonal shape, and D-shape. A ratio of the wall thickness of the microtubes to the external diameter of the microtubes can be in the range of 0.01 to 0.2. Examples of the materials from which the hollow microtubes can be made include, but are not limited to MgAlSi glasses, fused quartz and polymers.

According to another embodiment, the storage array structure includes a monolithic block having a plurality of cylindrical cavities formed therein which define the tubular chambers in the storage array structure.

According to still another embodiment, the storage array structure includes a plurality of closely packed hollow microtubes, as described above, and a monolithic block having a plurality of cylindrical cavities formed therein. The monolithic block can be aggregated together with said hollow microtubes.

According to a further embodiment of the present invention, the apparatus can further comprise a cooling system configured for cooling the storage array structure. For example, the cooling system can include a cooling chamber defining a cooling layer sandwiched between the outer surface of the storage array structure and the reinforcing layer. The cooling layer may surround at least a portion of the outer surface. The cooling chamber can be coupled to a coolant supply pipe, and equipped with a coolant valve mounted on the coolant supply pipe to open and close a path of coolant therethrough.

According to still another embodiment, the apparatus can further comprise a control system operatively coupled to the controllable gas valve and configured for controlling operation thereof.

According to one embodiment, the control system can include a pressure sensor arranged at the interface coupler. The pressure sensor can be configured for measuring gas pressure and producing a pressure sensor signal representative of the gas pressure within the tubular chambers of the array structure. The control system can also include a gas flow meter arranged at the interface coupler and configured for producing a gas flow sensor signal representative of gas flow within the interface coupler. The control system can include a controller operatively coupled to the pressure sensor and the flow meter. The controller can be responsive to the pressure sensor signal and the gas flow sensor signal and capable of generating control signals for controlling the operation of one or more controllable gas valves.

According to an embodiment of the invention, the control system can be further operatively coupled to the cooling system and configured for controlling operation thereof. For this purpose, the control system can, for example, further comprise a temperature sensor coupled to the outer surface of the array structure and configured for measuring the temperature. The temperature sensor can be configured for producing a temperature sensor signal indicative of the temperature of the outer surface. The controller can be operatively coupled to the temperature sensor and responsive to the temperature sensor signal for providing a control of said cooling system.

According to yet another embodiment of the invention, the control system can be configured for controlling operation of the safety valve.

The apparatus of the present invention has many of the advantages of the techniques mentioned theretofore, while simultaneously overcoming some of the disadvantages normally associated therewith.

The apparatus of the present invention is highly economical and operates with minimal losses of energy and gas.

The apparatus according to the present invention may be easily and efficiently fabricated and marketed.

The apparatus according to the present invention is of durable and reliable construction.

The apparatus according to the present invention may have a low manufacturing cost.

There has thus been outlined, rather broadly, the more important features of the invention so that the detailed description thereof that follows hereinafter may be better understood, and the present contribution to the art may be better appreciated. Additional details and advantages of the invention will be set forth in the detailed description.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic fragmentary longitudinal cross-sectional view of an apparatus for gas storage, according to one embodiment of the present invention;

FIGS. 2 A through 2C illustrate schematic transverse cross-sectional views of the apparatus of FIG. 1 taken along the line A-A therein, according to several embodiments of the present invention;

FIG. 3 is a schematic fragmentary longitudinal cross-sectional view of an apparatus for gas storage, according to another embodiment of the present invention;

FIG. 4 is a schematic fragmentary longitudinal cross-sectional view of an apparatus for gas storage, according to a further embodiment of the present invention;

FIG. 5 is a schematic fragmentary longitudinal cross-sectional view of an apparatus for gas storage, according to still a further embodiment of the present invention; and

FIG. 6 is a schematic fragmentary longitudinal cross-sectional view of an apparatus for gas storage, according to yet another embodiment of the present invention.

### DETAILED DESCRIPTION OF THE PREFERRED EMBODIMENTS

The principles and operation of an apparatus for gas storage according to the present invention may be better understood with reference to the drawings and the accompanying description. It should be understood that these drawings are given for illustrative purposes only and are not meant to be limiting. It should be noted that the figures illustrating various examples of the apparatus of the present invention are not to scale, and are not in proportion, for purposes of clarity. It should be noted that the blocks as well other elements in these figures are intended as functional entities only, such that the functional relationships between the entities are shown, rather than any physical connections and/or physical relationships. The same reference numerals and alphabetic characters will be utilized for identifying those components which are common in the apparatus and its components shown in the drawings throughout the present description of the invention.

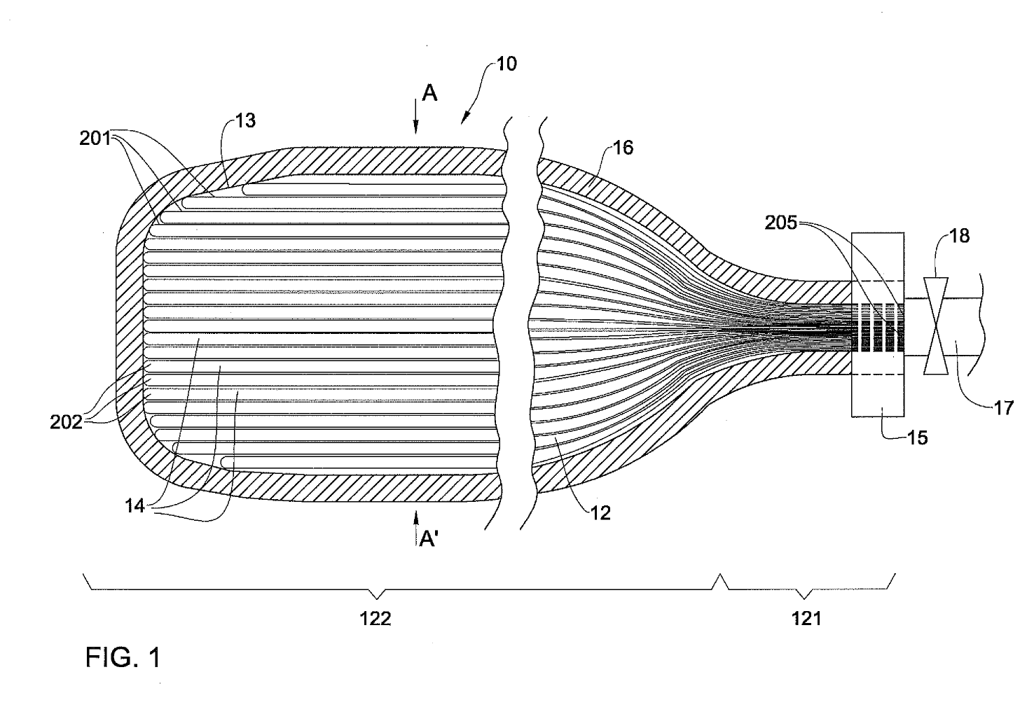

Referring to FIG. 1, a schematic fragmentary longitudinal cross-sectional view of an apparatus 10 for storage of gases is illustrated, according to one embodiment of the present invention. It should be noted that utilization of the apparatus of the present invention is not limited by any specific gas and can, for example, be used for storage and discharge of hydrogen, methane, oxygen, etc. When desired, a mixture of various gases can also be employed.

The apparatus 10 includes a storage array structure 12 that is constituted of a gas storage portion 122 which is tapered into a neck portion 121 at one end of the structure. The storage array structure 12 contains a plurality of tubular chambers 14 in the form of cavities (voids) for gas storage. The term “structure” is broadly used herein to describe a plurality of vessels, cartridges, capillaries, blocks of porous materials or other gas storage cells, which are bound together, and include a plurality of voids (chambers) configured for storage of compressed gas. Various ways of organization of the tubular chambers in the structure 12 will be described hereinbelow.

An outer surface 13 of the storage array structure 12 or at least a portion thereof is enveloped by one or more reinforcing layers 16 (only one reinforcing layer is shown in FIG. 1) that provide reinforcing strength to the structure 12. The reinforcing layer(s) 16 can have any desired thickness, shape and rigidity sufficient to provide a mechanical strength to the apparatus 10. Generally, the reinforcing layer(s) 16 can be made of any suitable metal, plastic or composite materials. For example, the reinforcing layers 16 can be made of carbon fiber reinforced epoxy. The thickness of the reinforcing layer(s) 16 can, for example be in the range of about 1 millimeter at gas storage portion 122 to about 10 millimeters at the neck portion 121 of the structure.

The apparatus 10 also includes an interface coupler 15 mounted on the reinforcing layer 16 at the neck portion 121 of the structure. The interface coupler 15 can include any coupling device or system configured for coupling the tubular chambers 14 of the storage array structure 12 to a gas pipe 17 through which gas can be supplied to the chambers 14 of the structure 12 or discharged (liberated) therefrom. For example, the interface coupler 15 can include a flange that couples the tubular chambers 14 to the gas pipe 17. In general, the interface coupler 15 can be constructed from any suitable metal, plastic or composite material and have shape and size suitable for the desired purpose.

The gas pipe 17 can further couple the array structure 12 either to a source of gas (not shown) in case of filling the gas storage apparatus 10, or to any desired consumer system (not shown), e.g. a fuel cell of a vehicle, utilizing the gas stored in the apparatus 10.

The flows (ingress flow and egress flow) of the gas through the gas pipe 17 can be regulated by a controllable gas valve 18 that can be aggregated with the interface coupler 15. Alternatively, the controllable gas valve 18 can be arranged at any place along the length of the gas pipe 17. The term “valve” as used herein has a broad meaning and relates to any electrical or mechanical device adapted for regulating the flow rate of the gas passing therethrough. Specifically, in order to fill the structure 12 with gas or discharge the gas from the structure 12, the controllable gas valve 18 should be opened to enable gas to flow into the chambers 14 of the storage structure 12 or out of them, respectively. After the filling or discharge of a desired amount of the gas, the gas flows are blocked by the corresponding operation of the controllable gas valve 18.

When desired, the interface coupler 15 can be directly connected to the controllable gas valve 18 which in turn can be coupled to the gas pipe 17.

According to one embodiment, the structure 12 includes a plurality of closely (densely) packed hollow microtubes (i.e., capillaries or microcylinders) 201 having ends 202 and 205 on opposite sides of the hollow microtubes 201. The ends 202 of the microtubes 201 on one side of the array structure 12 can be sealed. For example, the microtubes 201 can be capped or plugged on the ends 202 by semi-spheres with comparable wall thickness and featuring gas impermeability. Alternatively, the end 202 can be sealed by melting, brazing, soldering or any other method known in art. The sealed microtubes 201 define the open chambers 14 in the form of cavities or voids in the structure 12 in which the compressed hydrogen gas can be trapped and stored. The opposite (i.e. unsealed) ends 205 of the microtubes 201 can be coupled to the interface coupler 15. In order to couple the ends 205 of the microtubes 201 to the interface coupler 15, a cross-sectional dimension of the microtubes 201 must gradually decrease from the gas storage portion 122 towards the neck portion 121. The scaling factor (i.e., the ratio of a capillary dimension in the gas storage portion 122 of the apparatus 10 to the capillary dimension at the neck portion 121) can be in the range of about 10 to about 100.

The hollow microtubes 201 can be made of a material that has relatively small gas permeability and high tensile strength σ at low density ρ. For example, the materials that meet the condition σ/ρ>1700 MPa·cm³/g are suitable for the microtubes 201. Examples of the materials suitable for the microtubes 201 include, but are not limited to, MgAlSi glasses (e.g., S-2 Glass™, R glass available from Saint-Gobain Vetrotex Textiles, T Glass available from Nitto Boseki Co., Ltd. (Nittobo)), fused quartz, polymers (e.g., Kevlar™, Twaron™), etc.

Generally, the hollow microtubes 201 can have any desired length. In turn, the external diameter d of the microtubes 201 can be in the range of about 1 micrometer to about 5 millimeters. Magnitudes of wall thickness h of the microtubes 201 are defined by the value of the ratio h/d, that can be obtained from the equation h/d=ρ/(2σ), where ρ is the pressure of the hydrogen stored in microtubes 201 and σ is the tensile strength of the microtube material. For example, the ratio of the wall thickness to the external diameter is in the range of about 0.01 to about 0.1, depending on p and σ.

It should be noted that the external diameter d and wall thickness h of the microtubes located in the inner layers (i.e., in the bulk) of the structure 12 and the peripheral microcylinders can be different. In particular, the external diameter of the microtubes 201 can decrease from a center of the assembly structure towards edges (periphery) of the structure. By placing larger microtubes inside the structure and smaller microtubes towards the edges, a hydrogen accumulation and storage structure is created in which the wall tensions decrease towards the circumference due to lower diameter of the microtubes. Accordingly, the wall thickness h of the microtubes can increase from the center of the assembly structure towards the edges of the structure 12.

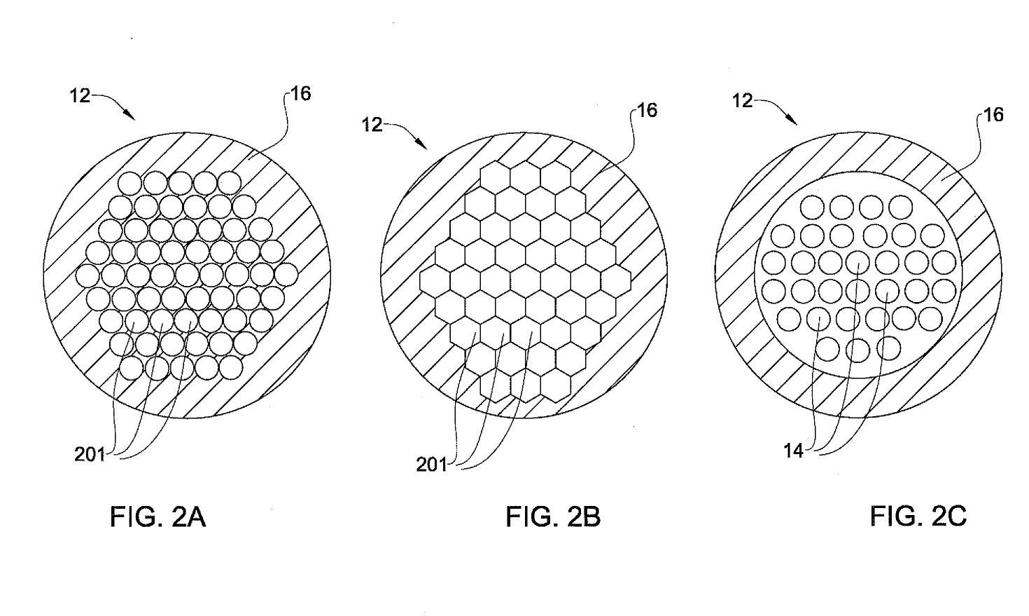

The microtubes 201 in the array structure 12 can have any desired shape in their cross-section. Examples of the cross-section shape of the microcylinders include, but are not limited to, round shape, oval shape, polygonal shape, hexagonal shape, D-shape, etc. FIGS. 2A and 2B illustrate examples of a schematic transverse cross-sectional view of the apparatus 10 of FIG. 1 taken along the line A-A′. As shown, in FIGS. 2A and 2B, the structure 12 has a plurality of the closely packed microtubes having round and hexagonal cross-sectional shape, correspondingly, which are enveloped by the reinforcing layer 16. It should be understood that when the cross-section shape is hexagonal (see FIG. 2B), the closest packing of the microtubes 201 can be obtained.

Preferably, the microtubes 201 are closely (intimately) packed in the structure. In other words, there is no empty space between the microtubes available for hydrogen. However, if the neighboring microtubes 201 are separated from each other, the space between their walls should be filled with a material, e.g., epoxy, glass, etc.

According to one non-limiting example, the microtubes 201 are closely packed, but they are not bound together.

According to another non-limiting example, the microtubes 201 are bound together to form a rigid structure. In this case, the microtubes can, for example, be tied together with a fastener (not shown), e.g., girded with a fastening band. Likewise, when the microcylinders are made of glass, aramid or metal, they can be bound together, for example, by welding, brazing and/or sintering. Moreover, an adhesive material, e.g., epoxy adhesives, can also be used for binding the microcylinders together.

It should be understood that the microtubes 201 can be closely packed in any suitable assembly and the structure 12 can have any desired shape for providing a conformable configuration to the apparatus 10 and making it suitable for transportation and conformation to the space available in a vehicle.

Methods for fabrication of the microtubes and the microtubular arrays are known per se. In particular, various microtubular (capillary) arrays made from glass and/or plastics are widely used in x-ray optics and photonics. Generally, the process of fabrication of microtubular arrays is divided into three main stages: (i) drawing glass tubes with relatively large diameter, (ii) re-drawing them into a bunch of capillaries with smaller diameter, and (iii) sintering the capillaries into the array. In order to taper the microtubular arrays for forming the neck portion 121, the bunch of capillaries can further be placed in a heated chamber or flame until the material of the capillaries softens, and thereafter can be drawn out as finely as desired.

The existing technology enables producing vast arrays with a microtube's diameter down to 1 micrometer or even less, and a wall thickness-to-diameter ratio less than 5%. For example, the arrays suitable for the purpose of the present invention can be obtained from Paradigm Optics, Inc.; 9600 NE 126th Ave, Suite 2540 Vancouver, Wash. 98682 USA; Joint Stock Company “Technology Equipment Glass Structures (TEGS)”, Prospect Stroiteley 1-B, Saratov, Russia, 410044, etc.

According to some embodiments of the present invention, the structure 12 includes a monolithic block having a plurality of cylindrical cavities (voids) formed therein. The cavities in the monolithic block define the chambers 14. According to this embodiment, the monolithic block can have any desired size and shape for providing a conformable configuration to the apparatus 10 and making it to be suitable for transportation and conformation to the space available in a vehicle.

Referring to FIG. 2C, an example of a schematic transverse cross-sectional view of the apparatus 10 of FIG. 1 taken along the line A-A therein is illustrated. According to this example, the structure 12 of the apparatus 10 includes a tubular monolithic block having a plurality of cylindrical cavities forming the chambers 14 having a round cross-section. A diameter of the cross-section of the cylindrical cavities can, for example, be in the range of about 1 micrometer to about 5 millimeters. The structure 12 is enveloped by a reinforcing layer 16.

It should be understood that the cavities may have any desired shape, such as oval shape, polygonal shape, hexagonal shape, D-shape, etc. Moreover, the dimension of the cavities may have any desired size distribution.

According to one embodiment, a distance between the neighboring cavities 14 may depend on the diameter, the pressure of the gas stored in the structure 12 and the tensile strength of the block material. For example, the diameters of the cavities 14 located in the inner layers (i.e., in the bulk) and near the periphery of the array can be different. In particular, the diameters can be reduced from a center of the structure 12 towards the periphery of the structure. Forming larger cavities inside the structure and smaller cavities 14 at the periphery can lead to the storage structure in which the material tension decreases from the center towards the circumference. Likewise, the distance between the neighboring cavities can be increased from the center of the structure towards the periphery.

According to this embodiment, the structure 12 can be formed from a monolithic block made of glass and/or plastics in which a plurality of cylindrical cavities (voids) are formed, for example by drilling. Examples of materials suitable for the monolithic block include, but are not limited to, MgAlSi glasses (e.g., S-2 Glass™, R glass available from Saint-Gobain Vetrotex Textiles, T Glass available from Nitto Boseki Co., Ltd. (Nittobo)), fused quartz, polymers (e.g., Kevlar™, Twaron™), etc. In order to form the neck portion 121, the monolithic block having cylindrical cavities can be further placed in a heated chamber or flame until the material of the block softens and then is drawn out as finely as desired.

According to some embodiments of the invention, the structure 12 can include a monolithic block having the plurality of cylindrical cavities aggregated together with a plurality of hollow microtubes. According to an embodiment, the monolithic block can be placed in the bulk of the structure, and then wrapped with the microtubes mounted on the periphery of the structure. For example, the microtubes can be wound around the monolithic block. The rate between the volume occupied by the monolithic block and the microtubes can have a predetermined value in order to provide optimal storage capacity of the apparatus 10.

According to another general aspect of the present invention, there is provided a method for filling the apparatus of the present invention with gas. According to an embodiment, the method comprises providing the apparatus 10 that includes the structure 12 containing a plurality of the tubular chambers 14 that is suitable for storage of gas. Further, the method includes providing a flow of gas in the pipe 17 into the tubular chambers 14 through the interface coupler 15. As a result, the structure 12 can be filled with a predetermined amount of the gas. To provide the desired gas amount, when required, access of the gas into the structure 12 through the tube 17 can be blocked by the valve 18.

According to a further general aspect of the present invention, there is provided a method for discharge (liberation) of the gas stored in the apparatus of the present invention. The method comprises providing the apparatus 10 that includes the structure 12 containing a plurality of the tubular chambers 14 that are filled with gas. Further, a controllable gas flow is provided to a consumer from the tubular chambers 14 of the structure 12 through the interface coupler 15 and through the pipe 17. As a result, a predetermined amount of the gas can be liberated from the structure 12.

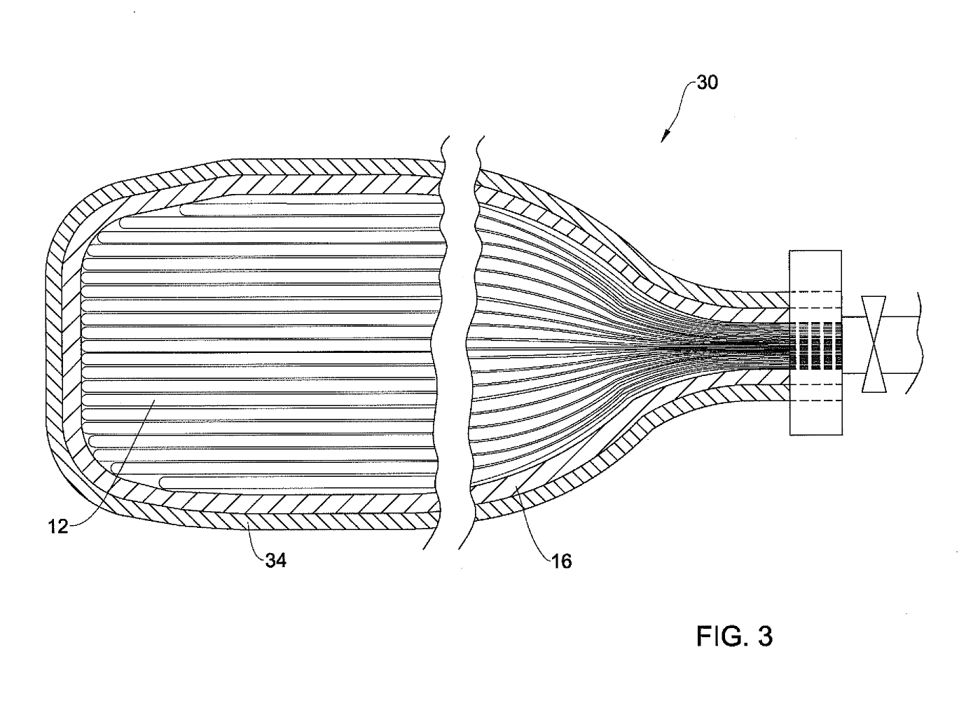

Referring to FIG. 3, a schematic fragmentary longitudinal cross-sectional view of an apparatus 30 for gas storage is illustrated, according to another embodiment of the present invention. The apparatus 30 differs from the apparatus (10 in FIG. 1) in the fact that at least a portion of the reinforcing layer(s) 16 is covered by a damping layer 34 that provides protection of the apparatus 30 from bumps, for example, during transportation of the apparatus.

The damping layer 34 has any desired shape. Preferably, but not mandatory, the damping layer 34 replicates the shape of the reinforcing layer 16. Generally, the damping layer 34 can be constructed of any suitable metal, plastic and/or composite materials, that have appropriate properties to provide damping. For example, the damping layer 34 can be made of a porous plastic and/or resin. The thickness of the damping layer 34 can be in the range of about 5 millimeters to about 20 millimeters. When desired, the damping layer 34 can be equipped with a carry handle (not shown) configured to facilitate a user to transport the apparatus 30.

It should be understood from the gas laws that when gas is loaded into the chambers of the structure 12, the temperature within the structure rises due to the compression of the gas. Accordingly, when the outer surface of the structure 12 or layers covering the structure are made of a material featuring a small heat conductance (e.g., a layer from carbon fiber reinforced epoxy), the heat generated within the apparatus will be “poorly” radiated to the exterior. The latter can overheat and damage the gas storage apparatus. Moreover, the raising of the temperature can sufficiently decrease an amount of gas that can be loaded into the structure. In order to avoid and/or alleviate these deficiencies, the gas storage apparatus can be equipped with a cooling system adapted for cooling the structure 12.

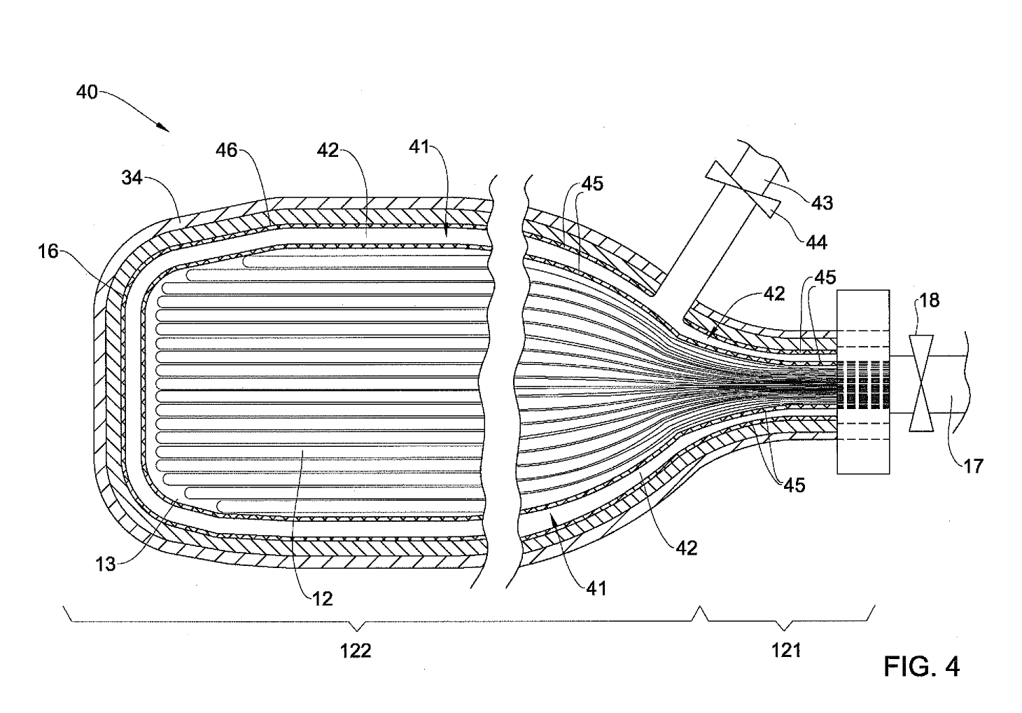

Referring to FIG. 4, a schematic fragmentary longitudinal cross-sectional view of an apparatus 40 for gas storage is illustrated, according to a further embodiment of the present invention. Generally, the apparatus 40 can include all the components of the apparatus (10 in FIG. 1) or the apparatus (30 in FIG. 3), and further include a cooling system 42 configured for cooling the structure 12 to implement a cryo-compression technique of hydrogen storage.

According to the embodiment shown in FIG. 4, the cooling system 41 includes a cooling chamber 42 surrounded with hollow walls 46, in which the narrow region 45 between the inner and outer wall is evacuated of air. Using vacuum as an insulator avoids heat transfer to the structure by conduction or convection. The cooling chamber 42 with hollow walls 46 defines a cooling layer. The cooling layer can, for example, be constructed as two thin-walled vessels nested one inside the other, and sealed together at their necks near or at the interface coupler 15.

According to the embodiment shown in FIG. 4, the cooling layer is sandwiched between the outer surface 13 of the storage array structure 12 and the reinforcing layer 16. However, when desired, the hollow walls 46 themselves can function as the reinforcing layer similar to the walls of a doubled walled vessel (sometimes referred to as a Dewar flask, vacuum-insulated flask or thermos). Such a doubled walled vessel is, for example, described in U.S. Pat. No. 872,795 to Burger, a disclosure of which is incorporated herein by reference.

The cooling layer can surround at least a portion of the outer surface 13. The cooling chamber 42 is coupled to a coolant supply pipe 43 coupled to a source (not shown) of cooling fluid, and equipped with a coolant valve 44 mounted on the coolant supply pipe 43 to open and close a path of cooling fluid therethrough.

Examples of the cooling fluid include, but are not limited to cooled air and cooled liquid. Preferably, liquid nitrogen featuring extremely low temperatures (less than −196° C.) can be utilized for filling the cooling chamber 42. The deep cooling of the storage array structure 12 with liquid nitrogen can increase hydrogen density at a given ultimate pressure that the tank can withstand. It should also be understood that tensile strength of glass may increase at low temperatures.

According to one embodiment, liquid nitrogen can flow from a liquid nitrogen source (not shown) and enter cooling chamber 42 through the coolant supply pipe 43. The flow of nitrogen through the coolant supply pipe 43 can be regulated by a controllable coolant valve 44. When nitrogen is used as coolant, the coolant supply pipe 43 can also regulate the arising of pressure of nitrogen vapor inside the cooling chamber 42.

The hollow walls 46 of the cooling chamber 42 can have any desired shape to provide effective cooling of the storage array structure 12. Generally, the hollow walls 46 can be made from any suitable metal, plastic or composite materials, sufficient for holding the coolant and providing the most efficient cooling of the structure 12. When liquid nitrogen is used as coolant, the thickness of the cooling layer defined by the cooling chamber 42 can be in the range of about 5 millimeters to about 50 millimeters.

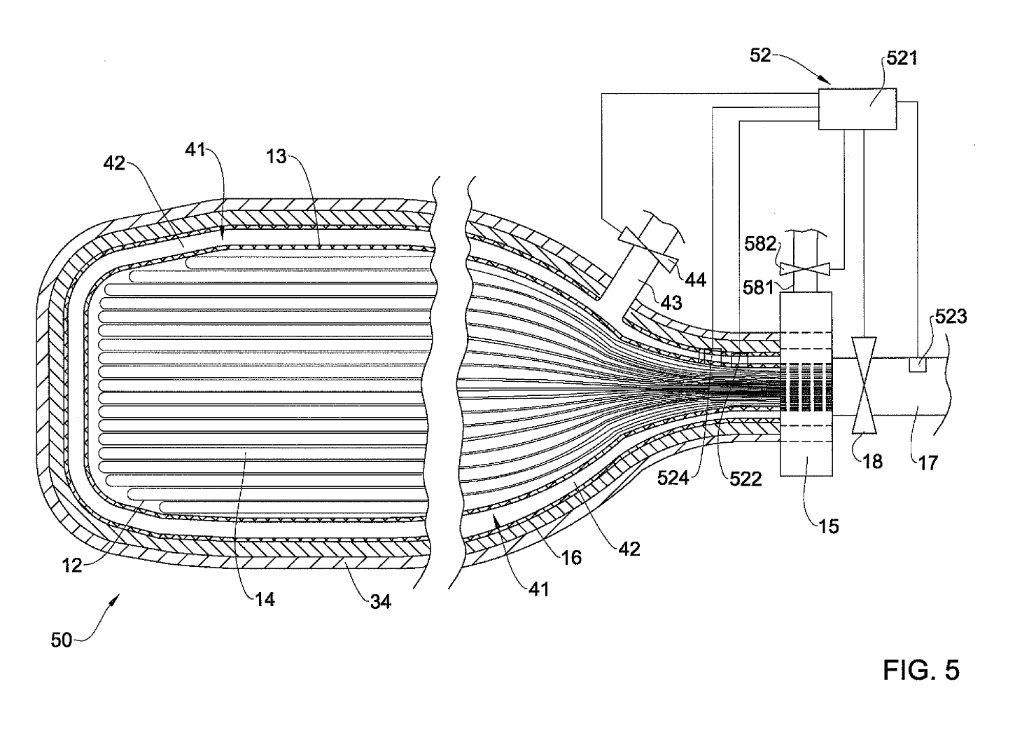

Referring to FIG. 5, a schematic fragmentary longitudinal cross-sectional view of an apparatus 50 for gas storage is illustrated, according to still another embodiment of the present invention. Similar to the embodiments described above, the apparatus 50 includes the storage array structure 12, the reinforcing layer(s) 16 enveloping the storage array structure 12, the damping layer 34, the interface coupler 15 coupling the voids (chambers) 14 of the structure to a source of gas or consumer system through the gas pipe 17 equipped with controllable gas valve 18. When desired, the apparatus 50 can include the cooling system 41 adapted for cooling the structure 12. The construction and function of all these elements are described above.

According to the embodiment shown in FIG. 5, the apparatus 50 also includes a safety valve 582 that can be automatically open when gas pressure in the structure 12 reaches a dangerous level. As illustrated in FIG. 5, the safety valve 582 can be arranged on a safety pipe 581 coupled to the chambers 14 and is adapted to regulate the gas flow through the safety pipe.

According to the embodiment shown in FIG. 5, the apparatus 50 further includes a control system 52 that is coupled, inter alia, to the controllable gas valve 18 and configured for controlling operation thereof. When required, the control system 52 can be coupled to the cooling system 41 and/or the safety pressure valve 582. Specifically, the control system 52 can be adjusted either automatically or manually to control operation of the controllable gas valve 18 and/or the safety pressure valve 582 to regulate the flow of the gas through the gas pipe 17 and the safety pipe 581, respectively. Likewise, the control system 52 can be adjusted to control operation of the cooling system 41 by controllably regulating the operation the controllable coolant valve 44.

The control system 52 includes a controller 521, a pressure sensor 522 coupled to the controller 521 and a gas flow meter 523 coupled to the controller 521. The controller 521 is an electronic device that can, inter alia, generate control signals to control operation of the controllable gas valve 18, the safety pressure valve 582.

The pressure sensor 522 can be arranged within the structure 12 and configured for measuring the gas pressure within the chambers (voids) 14, and producing a pressure sensor signal indicative of this pressure. The gas flow meter 523 can be arranged within the interface coupler or within the gas pipe 17 in the vicinity of the controllable gas valve 18. The gas flow meter is a device configured for measuring a rate of the gas flowing in the gas pipe 17, and producing at least one gas flow meter signal indicative of the flow rate. The signals produced by the pressure sensor 522 and the gas flow meter 523 can be relayed to the controller 521 via a connecting wire or wirelessly. In response to these signals, the controller 521 generates corresponding control signals to control operation of the controllable gas valve 18 and, when required, to the safety pressure valve 582.

As described above, the control system 52 can also be coupled to the cooling system 41 and configured for controlling operation thereof. In order to control the cooling system 41, the control system 52 can comprise a temperature sensor 524 that is coupled to the outer surface 13 of the structure 12 and configured for measuring the temperature thereof. Accordingly, the temperature sensor 524 is configured for producing a temperature sensor signal indicative of the temperature and relaying it to the controller 521 via a connecting wire or wirelessly. In its turn, the controller 521 provides controlling signals to the controllable coolant valve 44 for its operation to vary the flow rate of coolant within the cooling chamber 42, thereby to provide effective cooling of the structure 12 and to prevent its overheating and damage.

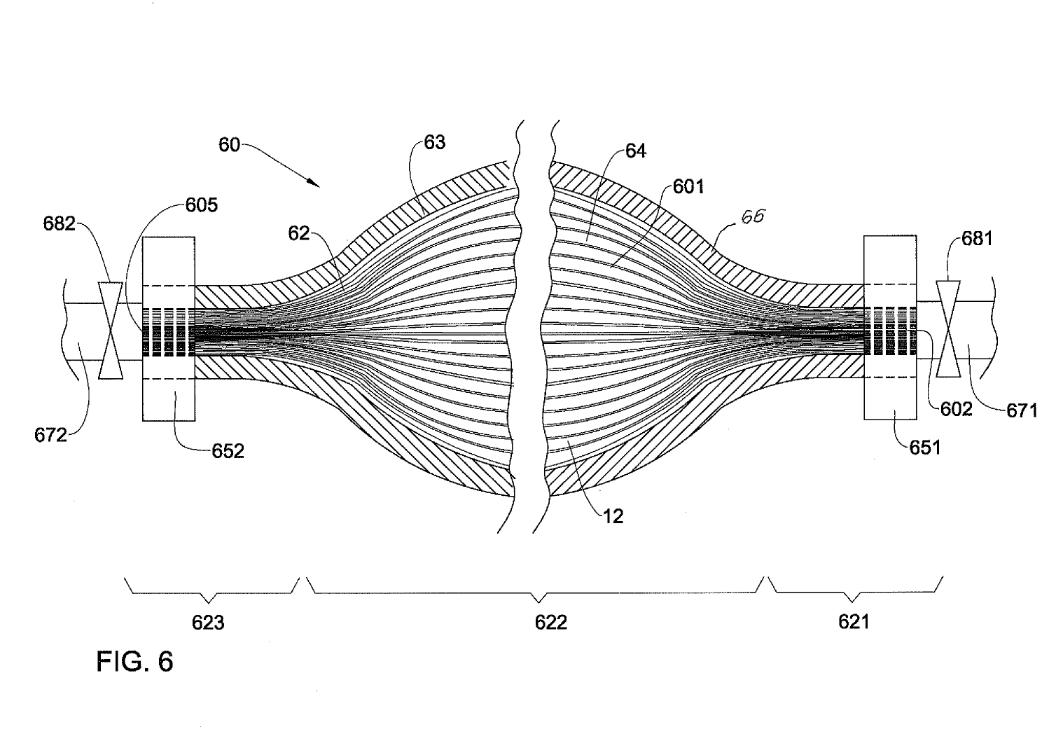

Referring to FIG. 6, a schematic fragmentary longitudinal cross-sectional view of an apparatus 60 for storage of gases is illustrated, according to yet another embodiment of the present invention. Examples of the gases include, but are not limited to, hydrogen, methane, oxygen, and a combination thereof.

The apparatus 60 includes a storage array structure 62 that is configured and operated for gas storage. The storage array structure 62 is constituted of a gas storage portion 622 which is tapered into a first neck portion 621 at one end of the structure and into a second neck portion 623 at another end of the structure 62. The storage array structure 62 contains a plurality of tubular chambers 64 in the form of cavities (voids) in which the compressed hydrogen gas can be trapped and stored.

An outer surface 63 of the storage array structure 62 or at least a portion thereof is enveloped by one or more reinforcing layers 66 (only one reinforcing layer is shown in FIG. 6) that provide reinforcing strength to the structure 62. The reinforcing layer(s) 66 can have any desired thickness, shape and rigidity sufficient to provide a mechanical strength to the apparatus 60. Generally, the reinforcing layer(s) 66 can be made of any suitable metal, plastic or composite materials. For example, the reinforcing layers 66 can be made of carbon fiber reinforced epoxy. The thickness of the reinforcing layer(s) 66 can, for example be in the range of about 1 millimeter to about 10 millimeters. When desired, the reinforcing layers 66 can be equipped with a carry handle (not shown) configured to facilitate a user to transport the apparatus 60.

The apparatus 60 also includes an interface inlet coupler 651 mounted on the reinforcing layer 66 at the first neck portion 621 of the structure 62, and an interface outlet coupler 652 mounted on the reinforcing layer 66 at the second neck portion 623 of the structure 62. The interface inlet and outlet couplers 651 and 652 can include any coupling devices or systems configured for coupling the tubular chambers 64 of the structure 62 to a gas inlet pipe 671 and to a gas inlet pipe 672 through which gas can be supplied to or liberated from the chambers 64 of the storage array structure 62, correspondingly. For example, the inlet and outlet interface couplers 651 and 652 can include corresponding flanges which couple the tubular chambers 64 to the gas inlet and outlet pipes 671 and 672. The interface inlet and outlet couplers 651 and 652 can be constructed from any suitable metal, plastic or composite material and have shape and size suitable for the desired purposes.

The gas inlet pipe 671 can further couple the array structure 62 to a source of gas (not shown) for filling the gas storage apparatus 60. Likewise, the gas outlet pipe 671 can further couple the array structure 62 to any desired consumer system (not shown), e.g. a fuel cell of a vehicle, utilizing the gas stored in the apparatus 60.

The ingress flow of the gas through the gas inlet pipe 671 can be regulated by a controllable gas inlet valve 681 that can, for example, be integrated with the inlet couplers 651. Alternatively, the controllable gas inlet valve 681 can be arranged within the gas pipe 671. Likewise, the egress flow of the gas through the gas inlet pipe 671 can be regulated by a controllable gas inlet valve 681 that can either be integrated with the outlet coupler 652 or arranged within the gas pipe 671. In order to fill the structure 62 with gas, the controllable gas valve 681 should be opened to enable gas to flow into the chambers 14 of the storage structure 62. Likewise, in order to discharge the gas from the structure 62, the controllable gas valve 682 should be opened to enable gas to flow from the chambers 64 of the storage structure 62. After the filling or discharge of a desired amount of the gas, the gas ingress and egress flows are blocked by the corresponding operation of the controllable gas valves 681 and 682, correspondingly.

According to one embodiment, the structure 62 can include a plurality of closely (densely) packed hollow microtubes (i.e., capillaries or microcylinders) 601 having ends 602 and 605 on opposite sides of the hollow microtubes 601. The ends 602 of the microtubes 601 are coupled to the interface inlet coupler 651. Likewise, the ends 605 of the microtubes 601 are coupled to the interface outlet coupler 652.

Dimensions of the packed hollow microtubes 601, their material, packing arrangement within the structure 62 and fabrication of the packed hollow microtubes 601 can be similar to the dimensions, material, packing arrangement and to the fabrication of the microtubes 201, as described above with reference to FIG. 1.

According to some embodiments of the present invention, the structure 62 can include a monolithic block having a plurality of cylindrical cavities (voids) formed therein. The cavities in the monolithic block form the chambers 64. According to this embodiment, the monolithic block can have any desired size and shape for providing a conformable configuration to the apparatus 60 and making it suitable for transportation and conformation to the space available in a vehicle. The dimensions of the cylindrical cavities and their arrangement within the monolithic block forming the structure 64 can be similar to the dimensions and arrangement of the cylindrical cavities within the monolithic block forming the structure 12, as described above with reference to FIG. 1.

It should be understood that similar to the apparatus 30 shown in FIG. 3, when desired, at least a portion of the reinforcing layer(s) 66 of the apparatus 60 can be covered by a damping layer (not shown) mutatis mutandis, that provides protection of the apparatus 60 from bumps, for example, during transportation of the apparatus.

Likewise, similar to the apparatus 40 shown in FIG. 4, when desired, the apparatus 60 can also include a cooling system (not shown), mutatis mutandis, configured for cooling the structure 62.

Further, similar to the apparatus 50 shown in FIG. 5, when desired, the apparatus 60 can also includes one or more safety valves (not shown) coupled to the chambers 64 mutatis mutandis, that can be automatically open when gas pressure in the structure 62 reaches a dangerous level.

According to an embodiment, the apparatus 60 can further includes a control system mutatis mutandis, that can control, inter alia, operation of at least one device selected from the controllable gas inlet valve 681, the controllable gas outlet valve 681, the safety valve(s), and the cooling system. Operation of such a control system is similar to the operation of the control system 52, as described above with reference to FIG. 5, mutatis mutandis.

As such, those skilled in the art to which the present invention pertains, can appreciate that while the present invention has been described in terms of preferred embodiments, the conception, upon which this disclosure is based, may readily be utilized as a basis for the designing of other structures systems and processes for carrying out the several purposes of the present invention.

Also, it is to be understood that the phraseology and terminology employed herein are for the purpose of description and should not be regarded as limiting.

Finally, it should be noted that the word “comprising” as used throughout the appended claims is to be interpreted to mean “including but not limited to”.

It is important, therefore, that the scope of the invention is not construed as being limited by the illustrative embodiments set forth herein. Other variations are possible within the scope of the present invention as defined in the appended claims. Other combinations and sub-combinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present description.

What is claimed is:

1. An apparatus for storage of a gas, comprising:
a storage array structure including a gas storage portion tapered into at least one neck portion at one end of the structure; said storage array structure including a plurality of tubular chambers for gas storage;
at least one reinforcing layer enveloping at least a portion of an outer surface of the storage array structure for providing reinforcing strength thereto; and
at least one interface coupler mounted on the reinforcing layer at said at least one neck portion and configured for coupling the tubular chambers of the storage array structure to at least one gas pipe through which the gas is supplied to the chambers or discharged therefrom.

2. The apparatus of claim 1, wherein said storage array structure includes a plurality of closely packed hollow microtubes having ends on the opposite sides of the hollow microtubes; the ends of the microtubes on one side of the array structure are sealed, whereas the ends on the opposite side are coupled to the interface coupler, thereby defining said tubular chambers in the form of cavities in the structure in which the compressed hydrogen gas are stored.

3. The apparatus of claim 2, wherein the hollow microtubes are made of a material having a ratio of the tensile strength to the density of the material greater than 1700 MPa·cm³/g.

4. The apparatus of claim 2 wherein an external diameter of the hollow microtubes decreases from the center of the structure towards the edges of the structure.

5. The apparatus of claim 2 wherein a wall thickness of the hollow microtubes decreases from a center of the structure towards edges of the structure.

6. The apparatus of claim 2, wherein a cross-sectional shape of the cavities in the structure is selected from round shape, oval shape, polygonal shape, and D-shape.

7. The apparatus of claim 2 wherein a ratio of the wall thickness of the microtubes to the external diameter of the microtubes is in the range of 0.01 to 0.2.

8. The apparatus of claim 2, wherein the hollow microtubes are made from materials selected from MgAlSi glasses, fused quartz and polymers.

9. The apparatus of claim 1 wherein said storage array structure includes a monolithic block having a plurality of cylindrical cavities formed therein which define the tubular chambers in said storage array structure.

10. The apparatus of claim 2 wherein said storage array structure further includes a monolithic block having a plurality of cylindrical cavities formed therein which define the tubular chambers storage array structure; said monolithic block being aggregated together with said hollow microtubes.

11. The apparatus of claim 1, wherein the reinforcing layers is made of carbon fiber reinforced epoxy.

12. The apparatus of claim 1, comprising at least one controllable gas valve coupled to the interface coupler, said at least one controllable gas is configured for regulating an ingress flow of the gas through said at least one interface coupler for filling said storage array structure, and/or an egress flow of the gas through the interface coupler.

13. The apparatus of claim 1, wherein at least part of the reinforcing layer is enveloped by a damping layer for protection of the apparatus from bumps.

14. The apparatus of claim 1, further comprising at least one safety valve coupled to the tubular chambers of the structure and configured for automatic opening when a pressure in the chambers reaches a dangerous level.

15. The apparatus of claim 1, further comprising a cooling system configured for cooling said storage array structure.

16. The apparatus of claim 15, wherein the cooling system includes a cooling chamber surrounded with hollow walls defining a cooling layer surrounding at least a portion of the outer surface, the narrow region between the inner and outer wall of the hollow walls is evacuated of air.

17. The apparatus of claim 16, wherein the cooling chamber is coupled to a coolant supply pipe, and equipped with a coolant valve mounted on the coolant supply pipe to open and close a path of coolant therethrough.

18. The apparatus of claim 12, further comprising a control system operatively coupled to said controllable gas valve and configured for controlling operation thereof.

19. The apparatus of claim 18, wherein said control system comprises:
a pressure sensor arranged at said at least one interface coupler and configured for measuring gas pressure and producing a pressure sensor signal representative of the gas pressure within the tubular chambers of the array structure,
a gas flow meter arranged at said at least one interface coupler and configured for producing a gas flow sensor signal representative of gas flow within the interface coupler, and
a controller operatively coupled to said pressure sensor and said flow meter, and being responsive to said pressure sensor signal and said gas flow sensor signal, said controller being capable of generating control signals for controlling the operation of said at least one controllable gas valve.

20. The apparatus of claim 18, further comprising a cooling system configured for cooling said storage array structure; said control system operatively further coupled to said cooling system and configured for controlling operation thereof, thereby to avoid overheating and damage the structure.

21. The apparatus of claim 20, wherein said control system further comprises a temperature sensor coupled to the outer surface of the array structure and configured for measuring the temperature and producing a temperature sensor signal indicative of the temperature of said outer surface, said controller being operatively coupled to said temperature sensor and responsive to said temperature sensor signal for providing control of said cooling system.

22. The apparatus of claim 18, further comprising at least one controllable safety valve; said control system being configured for controlling operation of said at least one safety valve.
